(19) United States
(12) Patent Application Publication
(10) Pub. No.: US 2019/0005486 A1
(43) Pub. Date: Jan. 3, 2019

(54) AUTOMATED ELECTRONIC PAYMENT SYSTEM

(71) Applicant: Melody Schlabach, Orrville, OH (US)

(72) Inventor: Melody Schlabach, Orrville, OH (US)

(21) Appl. No.: 15/635,738

(22) Filed: Jun. 28, 2017

(51) Int. Cl. G06Q 20/32; G06Q 20/20

(52) U.S. Cl. CPC G06Q 20/3278; G06Q 20/202

(57) ABSTRACT

An automated electronic payment system for enabling contactless payment at a number of electronic payment facilities. The automated electronic payment system includes an electronic communication device capable of running an application for communicating with the electronic payment facilities, a wireless communication device providing a unique wireless communication zone having a unique coverage area and zone identification credentials at the electronic payment facility, a server in communication with the electronic payment facilities and the electronic communication devices to process a variety of information and a wireless communication channel to enable communication between the electronic communication devices, the electronic payment facilities and the servers. The application running on the electronic communication device communicates with the wireless communication device associated with the electronic payment facility when in proximity and processes the user information, payment information and zone identification information to perform contactless payment at the electronic payment facility.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### Field of the Invention

The present invention relates generally to payment systems and methods, more specifically, to payment systems and methods that exploit a mobile cellular network in toll stations.

### Background of the Invention

Most forms of traditional toll payment systems involves the users to purchase a ticket or a pass. Regular uses of the toll routes rely on the purchase of long term pass through mobile applications or websites, or physical pass purchases at kiosks and toll counters at the toll facility or related offices. Each of these pass purchases require input from the user. This input can be speech, physical payment or virtual payment through a software interface. This often leads to unwanted wastage of time at toll facilities and affects the fast movement of the vehicles in that particular route. The user input required for travel wastes a traveler's time and can cause inconvenience when the input has to occur at a certain time or place.

Currently, most toll roads are equipped with an electronic toll-collection system, such as E-Z Pass in the northeastern United States or Sun-pass in the southeastern United States. The electronic toll-collection system detects and processes tolls electronically. Such electronic toll-collection systems are used in many parts of the United States and abroad, but are very similar in their construction. Basically, the electronic toll-collection systems use a vehicle-mounted transponder that is activated by an antenna on a toll lane. A person's account information is stored in the transponder. The antenna identifies your transponder and reads your account information. The amount of the toll is deducted and you're allowed through and/or a message is generated, such as “Go” or “low balance.”

Electronic toll collection is designed to make traffic flow faster, as cars don't have to stop to make a transaction. A number of different types of applications and devices are available in the prior art, which are herein incorporated by reference for their supportive teachings, and are as follows:

U.S. Patent No. 20060258367 A1 to Chiang Tung C shows a method for toll collection via a wireless network may include tracking a current position of a mobile station within a vehicle, and collecting a toll based on the current position of the mobile station.

U.S. Pat. No. 5,857,152 A to Mondex International Limited shows a system for toll payment by electronic cash identifies an electronic purse and effects value transfer over a communication system without stopping the mobile vehicle or person. Mobile identity MID is temporarily correlated with purse identity PID and one or another identity is erased on satisfactory or non-satisfactory completion of the transaction, thereby allowing non-payers to be pursued while preserving the principle of anonymity.

U.S. Patent Application No. 20110047009 A1 to Bancpass, Inc. shows system and method for making electronic payments for tolls, parking and related transactions. A customer downloads an application onto their personal electronic device and registers the customer's vehicle and financial account information with a provider. The application detects upcoming toll facilities and notifies the customer. The customer can accept the payment of the toll through the application, whereupon the provider makes a payment from the customer's designated account to the toll facility.

U.S. Pat. No. 6,661,352 B2 to Mark Iv Industries Limited shows RF roadway toll collection system uses an upstream reader to communicate with a vehicle borne transponder carrying a Smart Card to calculate the toll and debit the Smart Card balance in the amount of the toll payment required. A transaction manager is notified of the toll payment from the upstream reader and notifies a downstream reader of the vehicle identification and payment status. The downstream reader confirms the vehicle identification and payment status and signals if the toll has been paid.

U.S. Pat. No. 4,555,618 A to R L Associates shows a system especially adapted for facilitating the collection of tolls on highways, includes the provision of exteriorly visible bar codes or other machine-readable customer account identifications, on vehicles using toll roads. Issuance of the account identification elements enables the customer to pass assigned scanning locations where the elements are machine-read, and verified at a computerized station serving a selected number of scanning locations.

Through a computerized network, the scanned data is ultimately transmitted to credit-issuing companies, for billing to the customers who have used the machine-readable elements. The system permits a vehicle to continue past the scan point without stopping, thus offering maximum convenience to motorists, speeding up the flow of traffic, and reducing the number of personnel required at highway toll plazas.

However, none of the above incorporated by reference inventions and patents, taken either singly or in combination, is seen to disclose an invention with an object to provide with an improved system and method in a cellphone or a mobile telephone, enabled to detect at least one toll gate on a route the user carrying the cellphone or a mobile telephone is traversing, the application is enabled to pay a tax/fee that is being charged at a toll gate from the application both manually and automatically. Hence there exists a need for an improved system, which provides efficient automated contactless payment at these electronic payment facilities.

### SUMMARY OF THE INVENTION

The present invention relates to an automated electronic payment system for enabling contactless payment at a number of electronic payment facilities. The automated electronic payment system includes an electronic communication device capable of running an application for communicating with the electronic payment facilities, a wireless communication device providing a unique wireless communication zone having a unique coverage area and zone identification credentials at the electronic payment facility, a server in communication with the electronic payment facilities and the electronic communication devices to process a variety of information and a wireless communication channel to enable communication between the electronic communication devices, the electronic payment facilities and the servers. The application running on the electronic communication device communicates with the wireless communication device associated with the electronic payment facility when in proximity and processes the user information, payment information and zone identification information to perform contactless payment at the electronic payment facility.

The primary goal of the present invention is to provide a method and system for automatically paying a fee. The method manages electronic toll collection in a toll station. The system is characterized by at least one cell, associated to the toll station, for creating a coverage area with an area identification code, the cell receiving an area identification signaling message from a mobile terminal when the mobile terminal detects the area identification code of the coverage area of the cell, the area identification message including a code identifying a user, an authentication server, in communication with a payment module, where the user is previously registered, a payment module connected to the cell, receiving the area identification code of the mobile terminal and, in communication with the authentication server, triggers automatically the payment if the user is registered and allowing the vehicle going through the toll station.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 is a schematic view of the present automated electronic payment system for enabling contactless payment at the electronic payment facilities, according to an embodiment of the present invention;

FIG. 2 illustrates the schematic diagram showing the hardware and software components of the electronic communication device, according to an embodiment of the present invention;

FIG. 3 illustrates a block diagram showing the different components of the server associated with the wireless communication device installed at the electronic payment facilities, according to an embodiment of the present disclosure;

FIG. 4 is a flowchart showing the steps for enabling contactless payment at the electronic payment facilities such as toll both facilities, according to an embodiment of the present disclosure;

FIG. 5 is a schematic diagram showing the user interface of the application running on the electronic communication device of the user for making contactless payment at the electronic payment facilities, according to an embodiment of the present disclosure; and

FIG. 6 is a flowchart showing the steps of communication or data exchange between the server, electronic communication device of the user and the wireless communication device installed at the toll line or tollgate, according to an embodiment of the present disclosure.

### DETAILED DESCRIPTION OF THE INVENTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that software, hardware and logical changes may be made without departing from the spirit and scope of the present invention. The following detailed description is, therefore, not to be taken in a limiting sense, and the scope of the present invention is defined by the appended claims and their equivalents.

The present invention can be implemented on any communication device that has hardware components that can perform wireless and wired communication, such as, but not limited to, desktop computer, multi-purpose pocket computers, cellular telephones, personal multimedia devices, etc. and using the standard operations thereof in similar fashion. The various devices on which the applications that implement the present invention run may use one or more processors with different instruction-sets, architectures, clock-speeds, etc. and memory that may include high speed random access memory and may include non-volatile memory, such as one or more magnetic disk storage devices, flash memory devices, and other kinds of solid state memory devices, all a commonly used. The various applications that can implement the present invention run on electronic devices that may use at least one physical user interface or GUI device that provide the means of control and navigation within the operating system.

The present invention relates to an automated electronic payment system for enabling contactless payment at a variety of electronic payment facilities. The present contactless payment system can be employed at different electronic payment facilities such as, but not limited to, toll booths, parking facilities, and other similar locations.

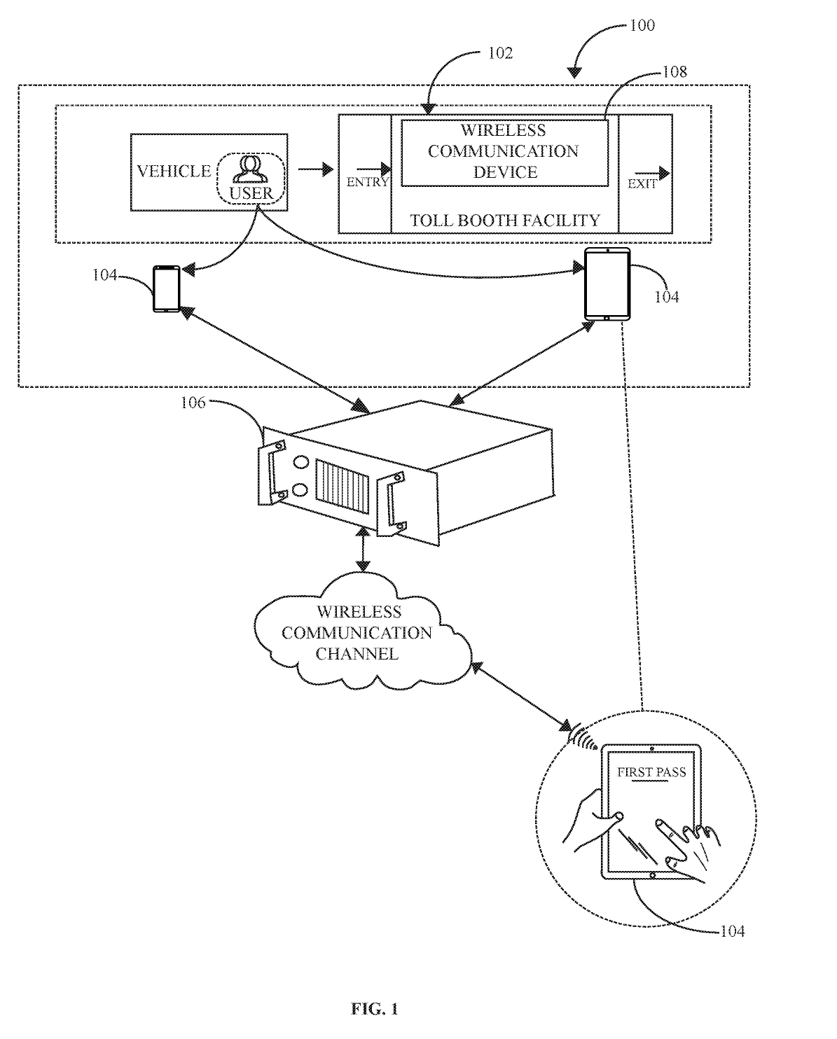

FIG. 1 is a schematic view of the present automated electronic payment system 100 for enabling contactless payment at the electronic payment facilities 102, according to an embodiment of the present invention. A first embodiment of the present invention is an automated electronic payment system 100 for facilitating contactless payment at tollbooths. The automated electronic payment system 100 includes an application that can be launched from or can be installed in one or more electronic communication devices 104 of the users. The users can register into the application by providing user information and payment information through a graphical user interface of the application. The electronic communication device 104 is equipped with a data or wireless communication module that enables the application running on the device to communicate with a central server 106 located at a remote location over a wireless communication channel or link established by the device 104. The wireless communication channel or link include either a mobile data communication network or a wireless LAN or similar wireless communication network capable of transferring the data provided by the user and transferring various types of data to the users through the application running on the electronic communication device 104. The automated electronic payment system 100 for electronic payment facilities such as tollbooths further includes a wireless communication device 108 associated with the electronic payment facility 102 to communicate with the electronic communication device 104.

In the case of a toll both electronic payment facility, according to an embodiment of the present invention, the wireless communication device 108 provides a unique coverage area, which is also limited in range, to cover each of the tool booth entries. In some instances, the wireless communication modules is provided with directional antennas for establishing unique communication zones or cells having limited coverage area restricted to a single toll both entry line. In a toll booth electronic payment system, the wireless communication modules are often left hanging from the roof and at a specific height to provide reliable and limited coverage area at each of the toll both entry line. In an embodiment, each of the wireless communication device 108 provides a unique wireless communication zone having unique coverage area and zone identification credentials at the electronic payment facility. The present automated electronic payment system 100 further includes the server 108 in communication with the electronic payment facilities 102 and the electronic communication devices 104 to process the information, such as, the user information, payment information, location information and zone identification information. The wireless communication device 108 provides one or more similar or different types of wireless communication channels, which communicate with the electronic communication device 104 of the user and the server 106 to fulfill the contactless payment at the electronic payment facility 102. In short, utilizing the present automated electronic payment system 100, the application running on the electronic communication device 104 communicates with the wireless communication device 108 associated with the electronic payment facility 102 when in proximity and processes the information, including the user information, payment information, location information and zone identification information to perform contactless payment at the electronic payment facility 102.

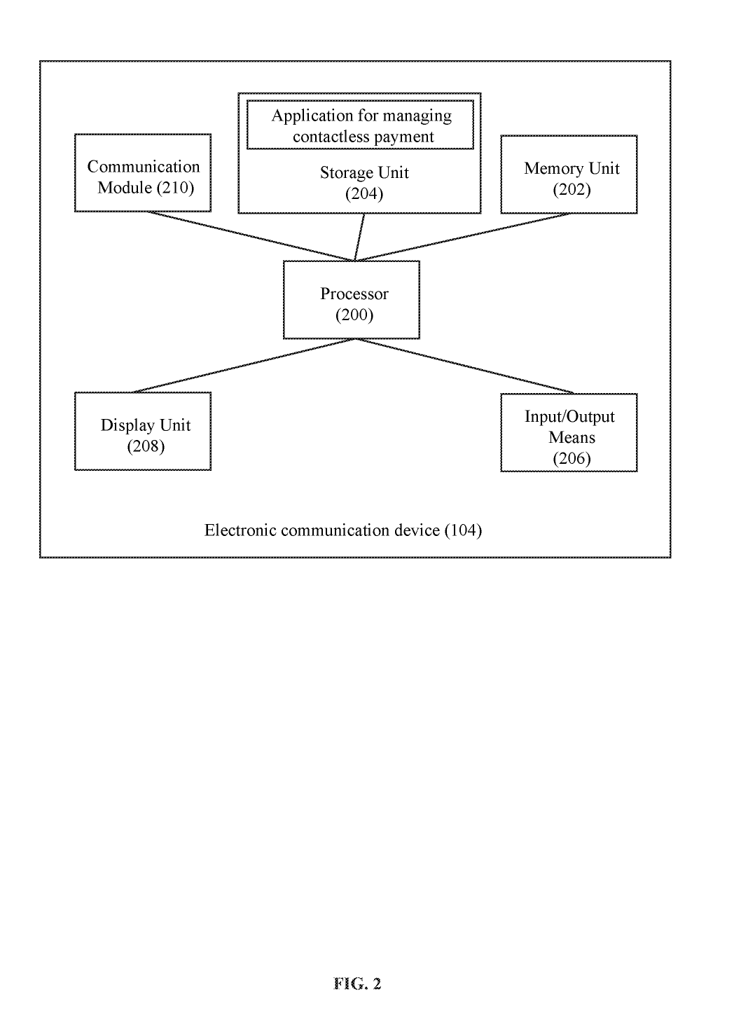

FIG. 2 illustrates the schematic diagram showing one embodiment of hardware and software components of the electronic communication device 104, according to an embodiment of the present invention. The electronic communication device 104 includes a processor 200, a memory unit 202, a storage unit 204, an input-output unit 206, a display unit 208, a communication module 210 and other necessary components for the proper operation of the electronic communication device 104. The electronic communication devices 104 includes smartphones, tablets or any other electronic communication device having the above components and capable of running the application for performing the contactless payment. The display means or display units 208 used by the electronic communication device 104 may include LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and these electronic devices 104. Connectivity of these devices 104 with networks, such as the internet, an intranet and/or wireless network, such as cellular telephone network, a wired or wireless local area network (LAN) and/or metropolitan area network (MAN) and/or WAN (wide area network) and other wireless communication is achieved by use of a plurality of communication standards, protocols and technologies like Bluetooth, Wireless Fidelity (Wi-Fi) and/or any other suitable communication protocol, including communication protocols not yet developed as of the filing date of this document. Moreover, the present invention maybe implemented on applications that run on a single or variety of operating system platforms, including but not limited to OS X, WINDOWS, UNIX, IOS, ANDROID, SYMBIAN, LINUX, or embedded operating systems, such as VxWorks. The present invention may also be implemented to work with various web browsers, including but not limited to Internet Explorer, Mozilla Firefox, Safari, and Opera, that access and handle various types of web pages constructed with various mark-up languages, such as HTML, HTML-5, XHTML, XML, etc. and the associated CSS (cascading style sheet) files and java-script files.

The users can access the application or download the application, which is available from an online application store such as, but not limited to, Google Play Store or App Store. The users are allowed to download the application and install in their electronic communication devices 104 such as smartphone prior to approaching the electronic payment facilities 102 for contactless payment. The users can launch the application and register into the application by providing a variety of user information and other payment information through a graphical user interface of the application displayed on the display unit 208 of the device 104. The communication module 210 associated with the electronic communication device 104 enables the communication of the application with the server 106 over a communication link established by the communication module 210. The communication link may include WLAN, mobile data communication or any other wireless communication means. The data provided by the users through the application are transferred to the server 106 through the communication link established by the communication module 210. In some instances, the present application may include additional security modules in form of encryption to protect the data transferred between the server 106 and the electronic communication device 104. In addition, the electronic communication device 104 also includes additional software or hardware modules for providing the location information using any known GPS module associated with the device 104.

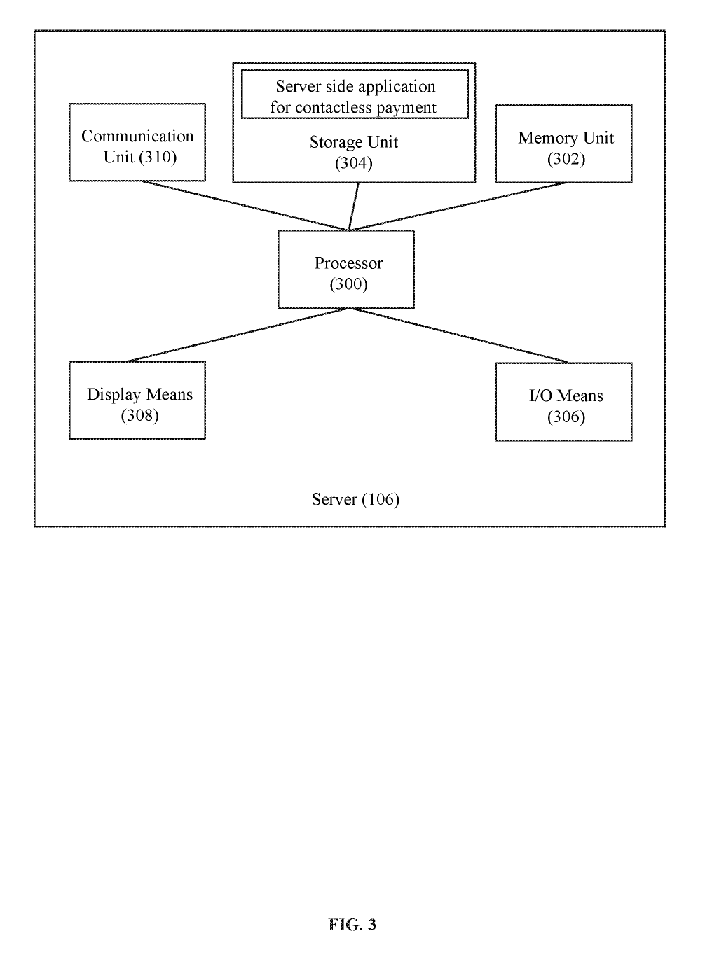

FIG. 3 illustrates a block diagram showing one embodiment of different components of the server 106 associated with the wireless communication device 108 installed at the electronic payment facilities 102 such as the tollbooths. The server 106 includes similar components as that of a computer such as a processor 300, a memory unit 302, a storage unit 304, an input-output unit 306, a display unit 308, a communication module 310 and other necessary components for the proper easy contactless payment at the electronic payment facilities 102. In an embodiment, the storage unit 304 of the server 106 stores an application, which is complementary and designed to directly communicate with the application running on the electronic communication device 104 of the user. The processor 300 executes a number of instructions of the application running on the server 106 and the communication module 310 communicates with the wireless communication device 108 installed at the electronic payment facility. In an embodiment, the wireless communication device 108 is installed at each tollgate of the tollbooth facility and left hanging from the top at a convenient height. Each wireless communication device 108 covers the associated tollbooth and whenever a vehicle comes within the coverage area of the particular toll gate of the toll booth, the wireless communication device 108 communicates with the application running on the electronic communication device 104 of the user.

According to an embodiment of the present invention, the present automated electronic payment system 100 is employed at tollbooth facilities for making efficient and fast toll payments through the application installed on the electronic communication device 104 of the users. The automated electronic payment system 100 employed at toll booth facilities 102 includes a number of wireless communication device 108 for providing unique coverage areas at each of the toll gates or toll lines at the toll booth facility. In some instances the wireless communication device 108 installed at the electronic payment facilities or at each toll line of the toll booth 102 includes one or more directional antennas for generating a unique wireless communication zone having the unique coverage area with the zone identification credentials. Each wireless communication device 108 creates a unique coverage area or cell or zone with unique zone identification credentials. These credentials are passed onto the server 106 along with the information received from the electronic communication device 104 of the users approaching the particular toll line or cell. The wireless communication channel established by the wireless communication device 108 hanging from the top of the toll line or installed at the proximity of the toll line includes a mobile data communication channel. The coverage area or cell for each of the toll lines at the toll booth facility 102 are created by direction antennas equipped wireless communication devices 108 and covers certain area of the toll line and has unique credentials to communicate with the application running on the electronic communication device 104 of the users and the server 106. This also helps to track the payment and entry-exit information of each of the vehicles passing through the particular tollgate or toll line. The directional antennas associated with each of the wireless communication device 108 prevent interference of the cells or the coverage areas in adjacent toll lines at the tollbooth facility 102. In certain embodiment, the wireless communication device 108 installed at the electronic payment facility 102 includes a transponder to enable a first wireless communication channel to communicate with the electronic communication device 104 and a second wireless communication channel to communicate with the server 106. The first and second wireless communication channel can be of the same type such as mobile data communication or different types such as Bluetooth or cellular. In some instances, the wireless communication device 108 also capable of receiving or transferring the GPS coordinates or location coordinates of the toll line where the device 108 is installed.

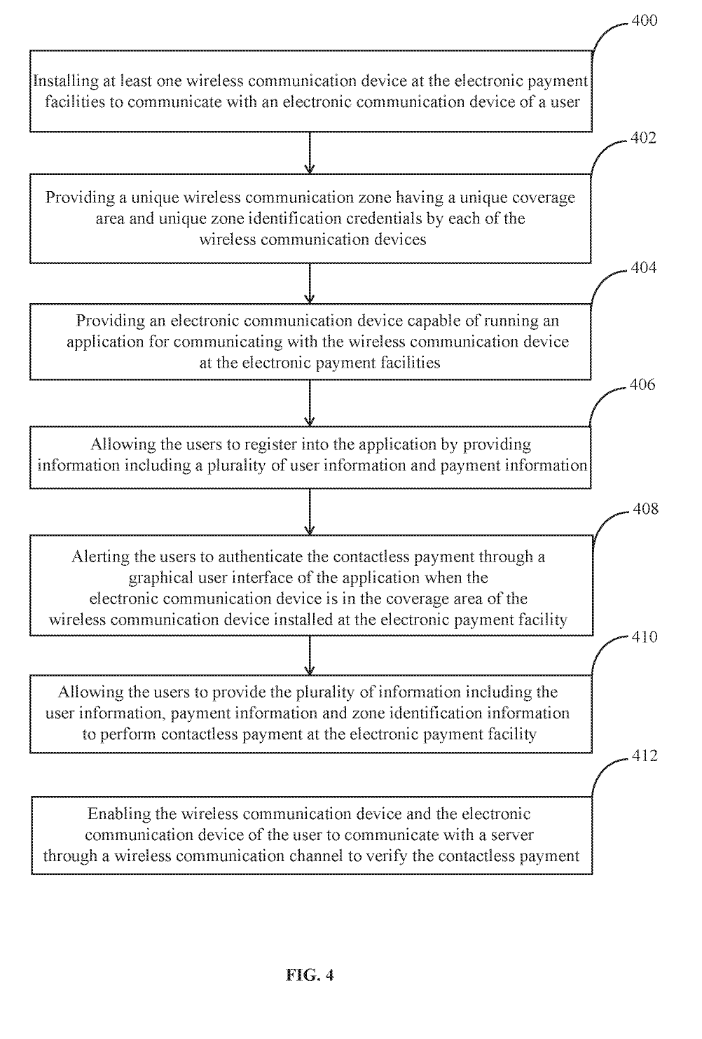

FIG. 4 is a flowchart showing one embodiment of the steps for enabling contactless payment at the electronic payment facilities such as toll both facilities, according to an embodiment of the present disclosure. The method for enabling contactless payment at the electronic payment facilities such as toll both facilities includes the steps of providing proper arrangements at the existing or newly constructed tollbooth facilities. These arrangements include the installation of the wireless communication devices 108 at each of the toll lines, as shown in block 400. The wireless communication devices 108 are arranged overhead at a specific height at each of the toll lines. However, in some instances, the wireless communication devices 108 are installed near each toll line in such a way that the coverage area or the cells produced by each device 108 at adjacent toll lines do not overlap creating signal interference. Each of the wireless communication devices 108 is configured to provide a unique wireless communication zone having a unique coverage area and unique zone identification credentials, as described in block 402. Further, the wireless communication devices 108 communicate with the server 106 that is either located in proximity to the toll both or at a remote location. The wireless communication devices 108 communicate with the server 106 over a cellular data or mobile data network established by the wireless communication devices 108. However, other forms of communication channels such as WLAN or cable networks or fiber network for enabling communication between the wireless communication devices 108 and the server 106 can be used. In order to utilize the contactless payment at the toll booth facilities 102, the users are prompted to download and install or launch the application for managing the contactless payment in their personal electronic communication devices 104 such as smartphone, tablets, smart wearable device etc., as in block 404. The users are then prompted to register into the application through the graphical user interface of the application displayed on the display unit 208 of the electronic communication device 104 by providing a variety of information including personal information, payment information and other vehicle information, as shown in block 406. The server 106 runs an application configured to process the data received from the wireless communication devices 108 and the electronic communication device 104 of the users. The application running on the server 106 manages the user accounts of all users registered using the application running on the user's electronic communication devices 104 and the data received from the wireless communication devise 108 at the toll booths. When a vehicle approaches a toll line installed with the wireless communication device 108, the application running on the electronic communication device 104 of the user situated inside the vehicle automatically communicates with the wireless communication device 108 and alerts the user, as in block 408. The present electronic payment system 100 can be configured to perform automatic toll payments at the toll facility when the vehicle passes through the coverage area of the wireless communication device 108. As discussed above, the wireless communication device 108 installed at each toll line of the toll both facility 102 generates unique coverage areas, without overlapping, with a unique area identification code or zone identification credentials. When the electronic communication device 104 of the user travelling in a vehicle reaches the coverage area of a toll line or toll facility, the wireless communication device 108 associated with the toll line receives an area identification-signaling message from the electronic communication device 104 of the user. The wireless communication device 108 associated with the toll line receives the area identification signaling message, which also includes a unique code, assigned to the user for identifying the user. Further the users can see the details of the tollbooth payment through the graphical user interface of the application running on their electronic communication device 104. The users can provide the vehicle details and other relevant information, such as, but not limited to, the user information, payment information and zone identification information through the graphical user interface of the device 104 to perform contactless payment at the electronic payment facility, as in block 410. Now as in block 412, once the user information is received from the electronic communication device 104, the wireless communication device 108 communicates with the server 106 over the wireless communication channel such as a cellular network. The server 106 communicates with a secure payment module and performs user verification, for registered users and processes the cell identification information or the unique area identification code or zone identification credentials along with the vehicle details received from the user. Once all the necessary information is received from the users and from the toll line or the wireless communication device 108 installed at the particular toll line or cell, the server 106 initiates the payment authentication procedure. The users are instantly notified upon making a successful automated contactless payment at the toll facility through the application running on their electronic communication devices 104 and are allowed to pass through the toll line.

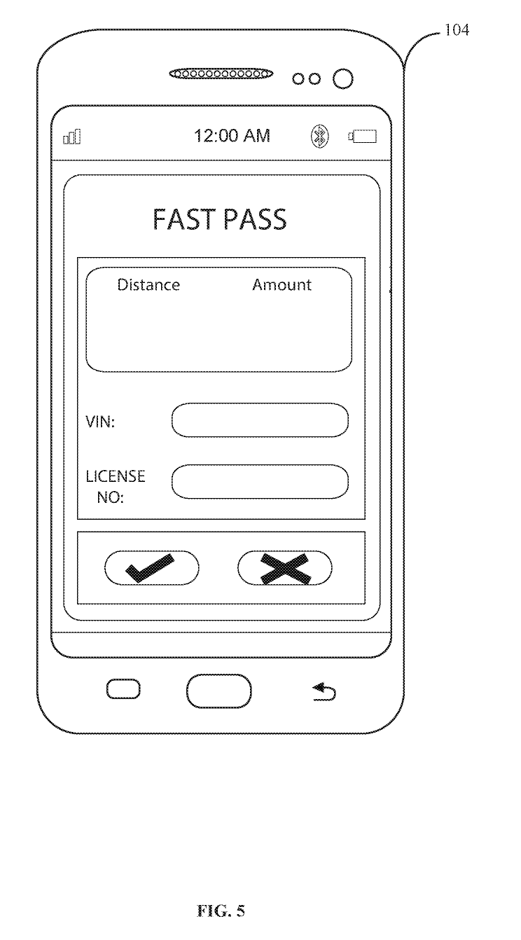

FIG. 5 is a schematic diagram showing the user interface of the application running on the electronic communication device 104 of the user for making contactless payment at the electronic payment facilities 102, according to an embodiment of the present disclosure. The application running on the electronic communication device 104 allows the users to register into the application as described above. When the vehicle carrying the user reaches the electronic payment facility 102, which can be a tollgate or toll facility or a parking facility, the users gets alerts through the application and are prompted to enter the vehicle details such as the vehicle identification number, VIN, number of the vehicle, license number of the vehicle and in some instances, the vehicle type etc. After providing all the requested details the users are prompted to make the payment using preconfigured payment methods or other instant payment methods. Once the server 106 in communication with the wireless communication device 108 installed at the electronic payment facility 102 and with the electronic communication device 104 of the user receives payment conformation from the associated payment module, the respective users are alerted through the application and are allowed to pass through the gate.

In some other instances, the application running on the electronic communication devices 104 of the users allows them to store desired amounts in form of credit points for faster payment at the toll booth facilities. This allows the users to easily pass through the toll lines as the payment will be completed automatically and the amount will be deducted from the credit points or credit value stored inside application. However, in some other instances, the application allows the users to link their exiting bank accounts or credit or debit cards to the application for faster and reliable payment at the tollbooth facilities.

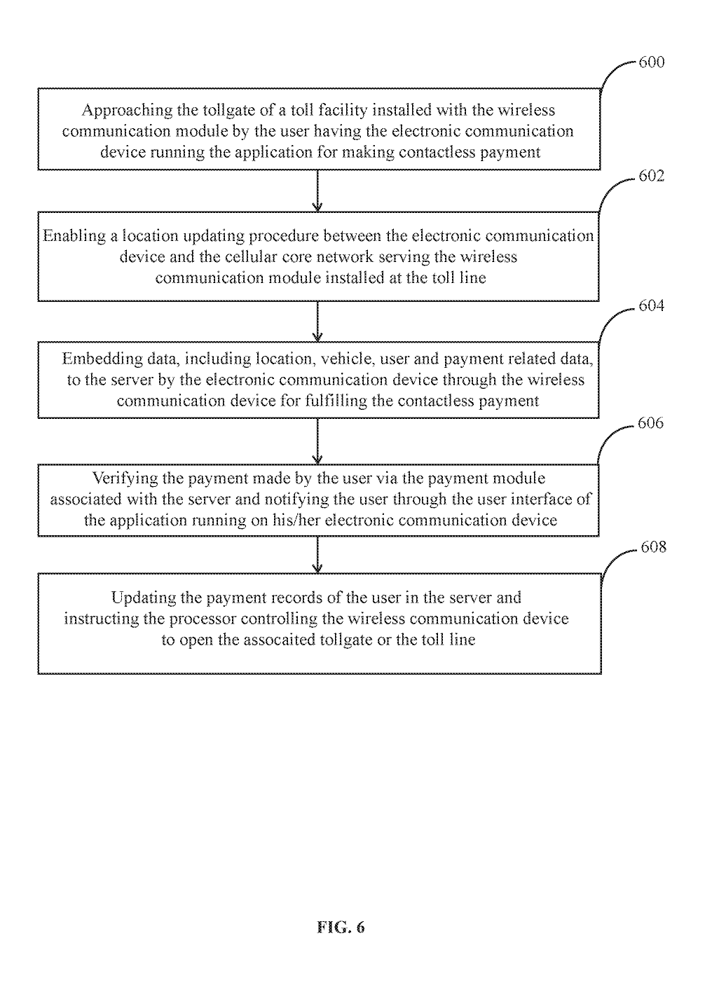

Moreover, the present invention is to facilitate a user with a method to automatically pay a toll while crossing the tollgate. FIG. 6 is a flowchart showing the steps of communication or data exchange between the server 106, electronic communication device 104 of the user and the wireless communication device 108 installed at the toll line or tollgate, according to an embodiment of the present disclosure. The method starts when a user travelling in a vehicle and having his/her electronic communication device 104 running the present application for making contactless payment, approaches the tollgate of a toll facility installed with the wireless communication module 108, as in block 600. The method comprise of a communication link where a processor associated with the wireless communication device 108 controls both the operation of the transponder and the operation of the communication link. The communication link can include a transducer where the processor controls the transducer to communicate both with the fee payment system or the payment module associated with the server 106 and for one or more of cellular communication, Bluetooth communication and GPS reception. The cells or the coverage areas of each wireless communication device 108 installed at each of the toll lines are connected to the payment module, which is in charge of controlling the payment procedure, associated with the server 106. The toll station is in the coverage area of some mobile operator(s), through e.g. a macro cell. The cell hanging from the toll station or from each of the toll line or toll gate, i.e. in an embodiment there is one cell per toll lane, lies in a location area, LA, which is different from that of the macro cell serving the toll area. Then, when the mobile or the electronic communication device 104 of the user enters the coverage area of one of the cells of the toll station, and due to the change of LA, it starts a location update procedure between the mobile and the cellular core network serving the cell and through the cell as in block 602. Then as in block 604, the mobile terminal or the electronic communication device 104 embeds useful data to the server 106 through the wireless communication device 108 that are used in the present invention for fulfilling the contactless payment. The location area refers to the area, identifying the location of a mobile terminal or the electronic communication device 104 when in idle mode. Depending on the cellular technology the term used to refer to this concept may be different, e.g., tracking area in LTE, location area in 3G, etc. As an alternative, other procedures, different from location area update, that embed the same identification information might as well be used. The payment module associated with the server 106 verifies the payment made by the user through the user interface of the mobile application running on his/her device 104, as in block 606. Once the payment is successful, the server 106 updates the associated database or payment records of the user and instructs the processor controlling the wireless communication device 108 to open the particular tollgate or the toll line, as in block 608. The application running on the electronic communication device 104 is also updated in real-time for user verification or reference.

In one embodiment of the invention, the present system and method is the application software operating in a cellphone or a mobile telephone 104, enabled to detect at least one toll gate on a route through which the user carrying the cellphone or a mobile telephone 104 is traversing. The application is enabled to pay a tax or fee that is being charged at a tollgate from the application both manually and automatically. In some other embodiment the present system and method is the wireless communication device 108 installed at each of the tollbooth facilities or toll lines for processing the contactless payment at the plurality of payment facilities. The wireless communication device 108 includes one or more processors configured to perform a number of tasks based on preset instructions. These tasks include instructing a wireless communication module associated with each of the device 108 to establish one or more unique wireless communication zones having a unique coverage area and unique zone identification credentials, communicating with the application running on the electronic communication device 104 of the user in proximity to enable contactless payment and communicating with the server 106 to manage a variety of user information and payment information over the wireless communication channel established by the wireless communication module.

Although the term “toll” is used herein, the methods and devices disclosed herein also apply to paying any fee using an electronic toll-collection system, while in a vehicle or not and just walking past a tollbooth. Such activities include, but are not limited to such as parking fees, movie tickets, concert tickets, amusement parks, water parks, national and state parks, parking garages, Broadway shows, Olympic events, car races, and sporting events like football and baseball, even rodeo events, etc. In this regard, the term “fee” is intended to be general and to encompass payment of a fee to enable a user to continue or proceed to another location beyond or past the tollbooth physical location. The present methods and devices also have utility in paying other fees while in an automobile, such as for automatically paying for fast food while driving through a drive through window. Furthermore, although described with regard to automobiles, such devices and systems are application to other modes of transportation, such as motorcycles, boats, trains, aircraft, and non-vehicle usage such as walking or running. Further, a vehicle is not necessary as the devices and methods described herein can be implemented on hand held electronic devices 104 carried by a person. In an alternate embodiment, the electronic payment facilities 102 of the present disclosure include toll booths, parking facilities, other public fees payment locations installed with the wireless communication device 108 to facilitate contactless payment using the electronic communication device 104 of the user. In all such cases, the present system 100 of the invention, according to an alternate embodiment, has a number of communication cells, each associated with a mobile telecommunication network, and are hanging from a toll station or the payment facility 102. Each cell has certain features, such as covering one specific zone of a tolling area or payment area or pay line, for example a toll lane to avoid interference with adjacent toll lanes. Thus the system 100, in one embodiment, makes a difference by identifying through which toll lane a vehicle is crossing the toll. This requires the use of directional antennas, which are antennas that radiate greater power in one direction allowing for increased performance in transmission and reception and reduced interference from unwanted sources. Thus, a mobile terminal 104 approaching to the toll station establishes a communication with the corresponding cell using the directional antenna at the toll line or at each cell.

Further, it should be noted that the steps described in the method of use can be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, structural requirements, available materials, technological advances, etc., other methods of use arrangements such as, for example, different payment methods within above-mentioned list, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. An automated electronic payment system for enabling contactless payment at a plurality of electronic payment facilities, comprising:
a) an electronic communication device, designed for communicating with the plurality of electronic payment facilities;
b) at least one wireless communication device associated with the electronic payment facility to communicate with the electronic communication device,
wherein each of the wireless communication device provides a unique wireless communication zone having a unique coverage area and zone identification credentials at the electronic payment facility;
c) at least one server in communication with the electronic payment facilities and the electronic communication devices to process a plurality of information; and
d) at least one wireless communication channel to enable communication between the electronic communication devices, the electronic payment facilities and the servers;
wherein the electronic communication device communicates with the wireless communication device associated with the electronic payment facility when in proximity to each other and thereby processes the plurality of information including user information, payment information and zone identification information to perform contactless payment at the electronic payment facility.

2. The automated electronic payment system of claim 1, wherein the electronic payment facilities include toll booths, parking facilities, entertainment events, general events, and public and private parks to facilitate contactless payment through the electronic communication device of the user.

3. The automated electronic payment system of claim 1, wherein the application configured to run on the electronic communication device includes a graphical user interface for displaying the information including the user information, at least one vehicle information and at least one payment information.

4. The automated electronic payment system of claim 3, wherein the graphical user interface of the application allows the users to authenticate the payments at the plurality of electronic payment facilities in proximity thereto.

5. The automated electronic payment system of claim 1, wherein the wireless communication device installed at the electronic payment facility includes at least one directional antenna for generating the unique wireless communication zone having the unique coverage area with the zone identification credentials.

6. The automated electronic payment system of claim 1, wherein the wireless communication device installed at the electronic payment facility includes a transponder to enable a first wireless communication channel to communicate with the electronic communication device and a second wireless communication channel to communicate with the server.

7. The automated electronic payment system of claim 6, wherein the first wireless communication channel and the second communication channel includes cellular communication.

8. The automated electronic payment system of claim 6, wherein the wireless communication device installed at the electronic payment facility further shares GPS coordinates of the electronic payment facility with the sever and the electronic communication device of the user.

9. A method for enabling contactless payment at a plurality of electronic payment facilities, including the steps of:
a) installing at least one wireless communication device at the electronic payment facilities to communicate with an electronic communication device of a user,
wherein the wireless communication device is configured to provide at least one unique wireless communication zone having a unique coverage area and unique zone identification credentials;
b) providing the electronic communication device capable of running an application for communicating with the wireless communication device at the electronic payment facilities;
c) allowing the users to register into the application by providing a plurality of information including a plurality of user information and at least one payment information;
d) alerting the user to authenticate the contactless payment through a graphical user interface of the application,
wherein the application automatically communicates with the wireless communication device installed at the electronic payment facility when in proximity;
e) allowing the user to provide the plurality of information including the user information, payment information and zone identification information to perform contactless payment at the electronic payment facility; and
f) enabling the wireless communication device and the electronic communication device of the user to communicate with a server through a wireless communication channel to verify the contactless payment.

10. The method of claim 9, wherein the wireless communication device includes at least one transponder for communicating with the electronic communication device when in proximity and lies within a wireless coverage area established by the wireless communication device; and
wherein the transponder further communicates with the server for verifying a plurality of information including the user information and payment information.

11. A wireless communication device for processing at least one contactless payment at a plurality of payment facilities, comprising:
a) at least one processor configured to perform a plurality of tasks based on a plurality of preset instructions, the tasks include:
i) instructing a wireless communication module to establish at least one unique wireless communication zone having a unique coverage area and unique zone identification credentials;
ii) communicating with an application running on an electronic communication device of the user in proximity to enable contactless payment; and
iii) communicating with a server to manage a plurality of user information and payment information over a wireless communication channel established by the wireless communication module;
b) a wireless communication module for providing at least one wireless communication channel for communicating with an electronic communication device of a user in proximity; and
c) at least one processor for instructing the wireless communication module to communicate with the electronic communication device in proximity.

12. The wireless communication device of claim 11, further includes at least one transponder for communicating with the electronic communication device when in proximity thereto and lies within a wireless coverage area established by the wireless communication device.

13. The wireless communication device of claim 12, wherein the transponder further communicates with the server for verifying a plurality of information including the user information and payment information.

14. The wireless communication device of claim 11, wherein the electronic communication device includes smartphones, tablets or any other electronic communication device capable of running the application to communicate with the wireless communication device and the server.
